(19) United States
(12) Patent Application Publication
(10) Pub. No.: US 2003/0150145 A1
(43) Pub. Date: Aug. 14, 2003

(54) Device for & method of advertising a product

(76) Inventor: Loren T. Kretzschmar, Sedona, AZ (US)

Correspondence Address: CONNORS ASSOCIATES, 1600 DOVE ST, SUITE 220, NEWPORT BEACH, CA, 92660

(21) Appl. No.: 10/364,079

(22) Filed: Feb. 11, 2003

Related U.S. Application Data
(60) Provisional application No. 60/356,552, filed on Feb. 13, 2002.

(51) Int. Cl. G09F 1/08

(52) U.S. Cl. 40/538

(57) ABSTRACT

A uniquely shaped boat fender is used in a method of advertising a product sold in a container having a predetermined size and shape and bearing a distinctive label or having a distinctive feature. The boat fender acts as a shock absorber and has a size that is substantially larger than the predetermined size of the product container but has substantially the same shape and bears substantially the same label or has substantially the same distinctive feature. The boat fender has an attachment member extending therefrom that enables it to be attached to a boat in a manner that positions the boat fender along a side of the boat, to thereby advertise the product.

### RELATED PATENT APPLICATION & INCORPORATION BY REFERENCE

This application is a utility application based on U.S. provisional patent application Serial No. 60/356,552, entitled “Device & Method For Advertising A Beverage,” filed Feb. 13, 2002. This related application is incorporated herein by reference and made a part of this application. If any conflict arises between the disclosure of the invention in this utility application and that in the related provisional application, the disclosure in this utility application shall govern. Moreover, Applicant incorporates herein by reference any and all U.S. patents, U.S. patent applications, and other documents cited or referred to in this application or cited or referred to in the U.S. patents and U.S. patent applications incorporated herein by reference.

### DEFINITIONS

The words “comprising,” “having,” and “including,” and other forms thereof, are intended to be equivalent in meaning and be open ended in that an item or items following any one of these words is not meant to be an exhaustive listing of such item or items, or meant to be limited to only the listed item or items.

### BACKGROUND OF INVENTION

Beverages come in a variety of different sized and shaped containers and bear labels identifying the beverage by a trademark. The label has a distinctive coloring, shape and/or wording that consumers associate with their favorite brand of beverage. Often the shape of the container is unique and has acquired meaning as a trademark because consumers recognize the unique shape of the container as the one that holds the desired beverage. The Coca-Cola® bottle is an example of such a container. The beverages may be alcoholic or non-alcoholic and the containers come in convenient to carry and use sizes such as 12 ounce cylindrical cans, quart bottles, and 1.5 liter wine carafes, for example.

The same consumers of the beverages many times are recreational boaters. In order to protect their boats during docketing, boat bumpers referred to as fenders are hung along the side of the boat that is next to the pier at which the boat is being docked. Typically, a boat fender is attached to both the fore and aft of the boat, so that these fenders are between the side of the boat and the pier, avoiding direct contact between the boat's side and the pier to prevent the boat from being damaged. The fenders are at least in part made of a resilient material such as vinyl, rubber or polyurethane. These boaters are frequently extremely loyal to a particular brand of beverage.

### SUMMARY OF INVENTION

This invention, with its several desirable features, is summarized in the CLAIMS that follow. After reading the following section entitled “DETAILED DESCRIPTION OF SOME EMBODIMENTS OF THIS INVENTION,” one will understand how the features of this invention provide its benefits. The benefits of this invention include, but are not limited to: convenience of use, and most importantly, a low cost way to advertise a product.

This invention capitalizes on the loyalty of a boater to particular product brands to promote or advertise this brand of product by hanging from the boat a boat fender imitating or simulating the container for the product. Boaters are motivated to purchase such fenders and use them during docking, displaying the advertisement, because of their desire to identify with their favorite brand of product. This invention especially capitalizes on a boater's loyalty to his or her favorite beverage, but may also be used to advertise for example such other products as candy, cigarettes, or perfumes.

Without limiting the scope of this invention as expressed by the claims that follow, some, but not all, of its features are:

One, the method of this invention is most suited to advertise a product, for example, a beverage sold in a container having a predetermined size and shape and bearing a distinctive label or having a distinctive feature such as its shape. A unique boat fender is used that acts as a shock absorber and has a size that is substantially larger than the predetermined size of the container but has substantially the same shape and bears substantially the same label or has substantially the same distinctive feature as the container. In other words, the boat fender has an appearance that the boater or others will immediately recognize as a simulation of the container for the product being advertised.

Two, the boat fender has a body comprising a shock absorbing material, being made, at least in part, of a resilient material, such as, for example, vinyl, rubber or polyurethane. This boat fender has an attachment member extending from it that enables the boat fender to be attached to a boat in a manner that positions the boat fender along a side of the boat. This boat fender is attached to the boat positioning it along a side of the boat to thereby advertise the product. Typically, there is indicia on the exterior of the body of the fender corresponding to a trademark representing the brand of the product. This trademark is visible when the boat fender is attached to the boat.

Three, in the method of this invention an agreement must be reached between the owner of the trademark of the branded product to use the trademark in connection with the boat fender. Usually, the branded product has associated with it a famous trademark, and the entity selling the boat fenders bearing this trademark must be granted the legal right to so use the trademark. Thus, a license to make and sell a boat fender simulating the container is necessary to commercially exploit this invention, preferably, an exclusive license for this purpose.

Four, the boat fender may have many different shapes as determined by the container holding the brand of product being advertised. For example, in the case of beverages, it may be in the form of a long neck beer bottle, a short neck beer bottle, a soda can, a beer can, a wine bottle, a liquor bottle, etc. Usually its size is from about 3 to about 10 times larger than the container. Typically, the boat fender has a height of from about 12 to about 72 inches, a width of from about 4 to about 24 inches, and depth of about 4 to about 24 inches.

Five, the attachment member extends from the boat fender's body, usually, the top of the fender, enabling the boat fender to be manually attached to a boat in a manner that positions the boat fender along a side of the boat. This attachment member may be a flexible elongated element such as, for example, a rope typically having a length of from about 2 to about 6 feet. The attachment member may be a strap member, for example, one with connector including a hook portion and a fabric portion such as sold under the trademark Velcro®.

These features are not listed in any rank order nor is this list intended to be exhaustive.

### DESCRIPTION OF DRAWINGS

Some embodiments of this invention, illustrating all its features, will now be discussed in detail. These embodiments depict the novel and non-obvious device for and advertising method of this invention as shown in the accompanying drawing, which is for illustrative purposes only. This drawings includes the following figures (Figs.), with like numerals indicating like parts:

FIG. 1 is a side view of a boat fender used in the advertising method of this invention that is in the form of a long neck beer bottle.

FIG. 2 is a side view of a boat fender used in the advertising method of this invention that is in the form of a short neck beer bottle.

FIG. 3 is a side view of a boat fender used in the advertising method of this invention that is in the form of a soda or beer can.

FIG. 4 is a side view of a boat fender used in the advertising method of this invention that is in the form of a wine bottle with a hook and fabric attachment strap extending from the top of the fender.

FIG. 5 is a side view of a boat having the boat fender shown in FIG. 3 attached to the fore end of the boat and the boat fender shown in FIG. 1 attached to the aft end of the boat.

### DETAILED DESCRIPTION OF SOME EMBODIMENTS OF THIS INVENTION

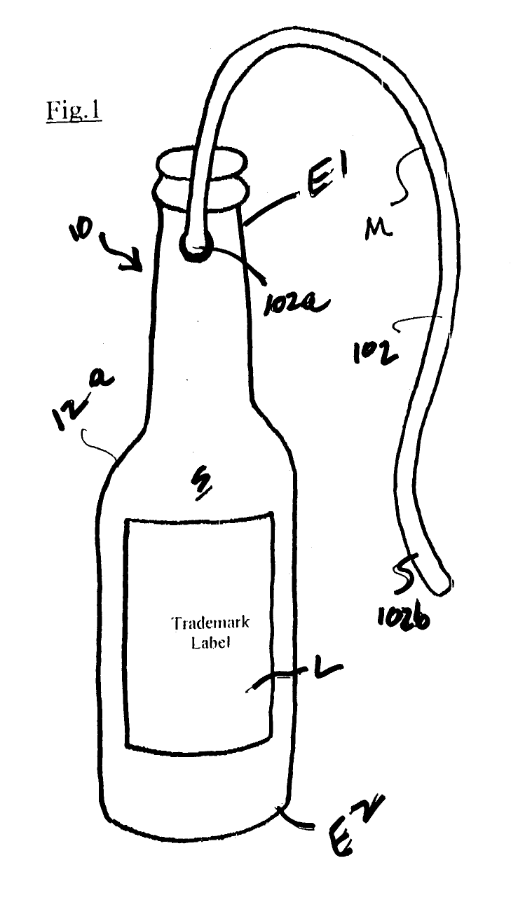

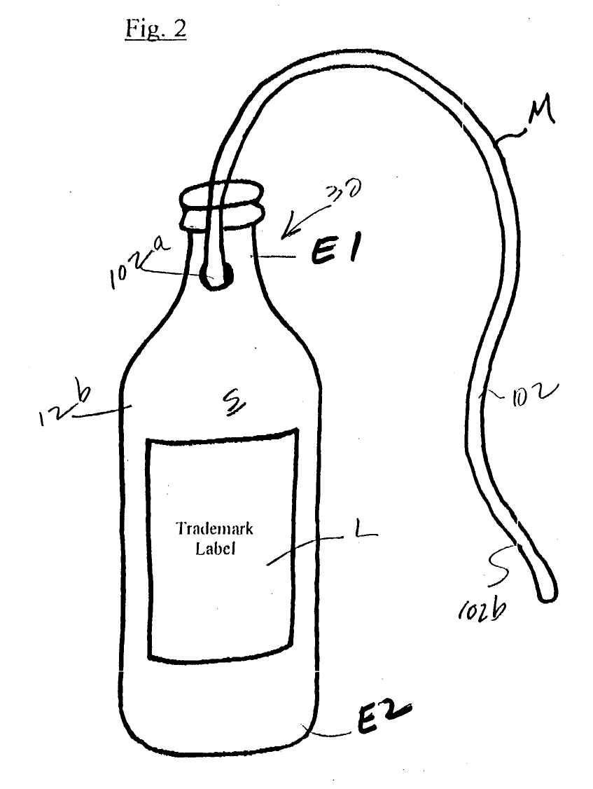

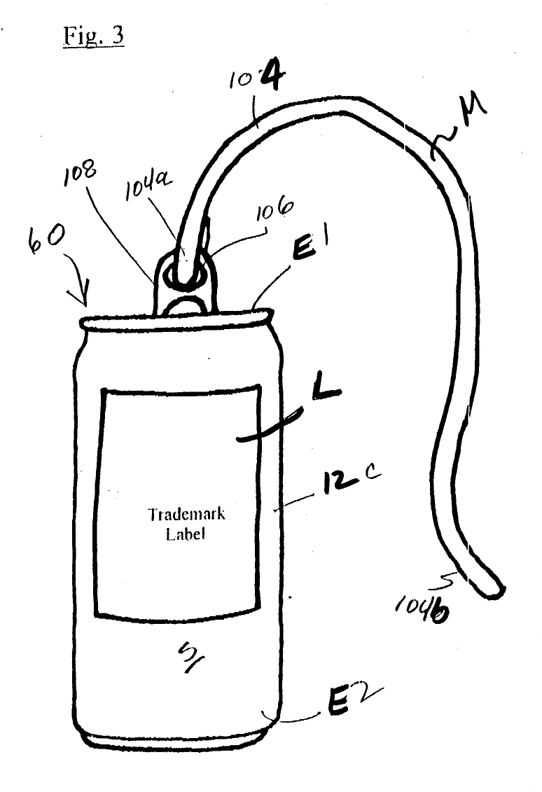

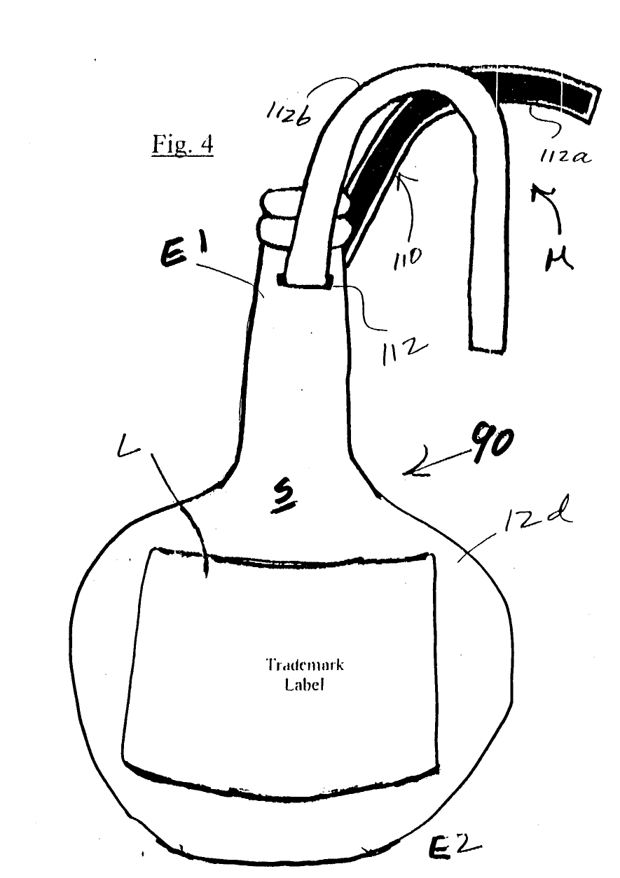

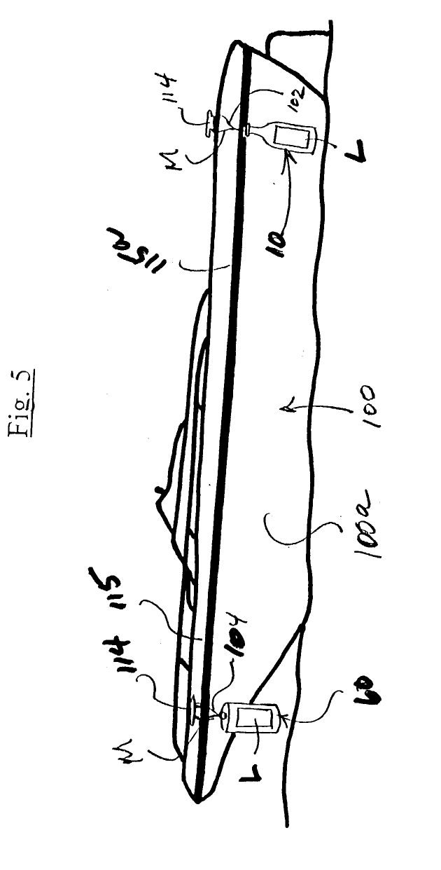

FIGS. 1 through 4 depict four different versions of a boat bumper or fender of this invention, the fender 10, the fender 30, the fender 60, and the fender 90, respectively. The boat fender 10 is in the form of a long neck beer bottle, the boat fender 30 is in the form of a short neck beer bottle, the boat fender 60 is in the form of a soda or beer can, and the boat fender 90 is in the form of a wine or liquor bottle. Each of these fenders 10, 30, 60 and 90 is used to advertise a brand of beverage according to the method of this invention, and each has a shock absorbing body 12a, 12b, 12c and 12d, respectively having a top end E1 and a bottom end E2. These bodies 12a, 12b, 12c and 12d may be hollow or solid. A flexible, elongated attachment member M extending from the top end E1 enables each boat fender 10, 30, 60 and 90 to be manually attached and detach to a boat 100 (FIG. 5).

Central to this invention is that each body 12a, 12b, 12c and 12d simulates the appearance of a beverage container and includes a distinctive feature serving as a trademark for the preferred beverage of the boater. This distinctive feature may be indicia corresponding to a trademark representing a particular brand of beverage. This trademark is visible when a boat fender is attached to the boat 100 as shown in FIG. 5. This distinctive feature may be (a) printed on, for example by silk screening, on an exterior surface S of the bodies 12a, 12b, 12c and 12d, or (b) an adhesive label L attached to the bodies 12a, 12b, 12c and 12d, or (c) selectively injecting colored material during molding of the bodies 12a, 12b, 12c and 12d, or (d) the unique shape of the bodies 12a, 12b, 12c and 12d themselves. Usually, each boat fender 10, 30, 60 and 90 has a size that is substantially larger than the beverage container that it simulates. The fenders 10, 30, 60 and 90 are from about 5 to about 10 times the size of the beverage container being simulated, typically about 7 times the size of the beverage container being simulated. Typically, each boat fender 10, 30, 60 and 90 has a height of from about 12 to about 72 inches, a width of from about 4 to about 24 inches, and a depth of from about 4 to about 24 inches. Even though larger than the beverage container being simulated, each boat fender 10, 30, 60 and 90 has substantially the same overall shape and appearance as the beverage container being simulated.

The attachment member M may have different forms. In the boat fenders 10 and 30, and it is a marine/nautical rope 102 that has one end 102a embedded in the bodies 12a and 12b, respectively. For example, as the bodies 12a and 12b are being molded, at least in part, from resilient material, the end 102a is placed in a mold (not shown) prior to the molten resilient material being poured into the mold. The rope 102 has a free end 102b used to attach the fenders 10 and 30 to the boat 100. The resilient material may be, for example, rubber or a plastic such as polyurethane. In the boat fender 60 simulating a cylindrical soda or beer can, a rope 104 has one end 104a looped through a hole 106 in a partially open tab 108 projecting outward from the top end E1 of this fender. The end 104a is tied or otherwise secured in place, leaving a free end 104b for attaching the fender 60 to the boat 100. In the boat fender 90 simulating a wine or liquor bottle, a strap 110 extends through a slot 112 in the top end E1 of this fender. There is a connector including a hook portion 112a near one end of the strap 110 and a fabric portion 112b near the other end of the strap that enables this portions to be connected together to facilitate attaching and detaching this fender to the boat 100. The Velcro Corporation sells a suitable marine/nautical hook and fabric fastener strap 110 suitable for use in this invention. Moreover, such a marine/nautical strap 110 that may be used in place of the rope 102 in connection with the other the fenders 10, 30, and 60.

As illustrated in FIG. 5, the method of advertising a branded beverage according to this invention comprises attaching at least one boat fender to the boat 100. The attachment member M is tied or otherwise secure to the boat 100 so that one, or more boat fenders, for example the fenders 10 and 60, hang along a side 110a of the boat 100. The attachment members M enable the boat fenders 10 and 60 to be attached to a cleat 114 near the gunwale 115 of the boat 100. A molding 115a is along the side of the boat 110. The attachment member M is sufficiently long so that boat fenders 10 and 60 hang along the side 100a of the boat 100 with their ends E2 below the gunwale 115. Typically, the attachment members M have a length of from about 2 to about 6 feet. Such display of the boat fenders 10 and 60 advertise the specific brand of beverage identified by these fenders and will be recognized by consumers of the beverage because the fenders 10 and 60 simulate the distinctive appearance of the branded beverage container.

The advertising method of this invention entails obtaining from the owners of the branded beverages a merchandising license to make the boat fenders 10, 30, 60 and 90 using the trademark associated with the beverage. Such a license grants to a licensed business the legal right to make the fenders. Without such a license, this business would infringe the legal rights of the owner of the trademark or dilute famous marks. Such a license would ordinarily require the payment of a royalty to the owner of the trademark by the licensed business. The owner of the trademark would get the benefit not only of a royalty, but also free advertising though use by boaters of the boat fenders 10, 30, 60 and 90 as discussed above. The business so licensed would have the right to make or have made and sell to boaters a boat fender simulating the container. The boaters would then attach to their boats one or more of the fenders 10, 30, 60 and 90 and thereby advertise the branded beverage.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A method of advertising a product sold in a container having a predetermined size and shape and bearing a distinctive label comprising the steps of
(a) providing a boat fender that acts as a shock absorber and has a size that is substantially larger than the predetermined size of the container but has substantially the same shape and bears substantially the same label, said boat fender having an attachment member extending therefrom that enables said boat fender to be attached to a boat in a manner that positions the boat fender along a side of the boat, and
(b) attaching the boat fender to the boat along a side of the boat to thereby advertise the product.

2. The method of claim 1 where the boat fender is in the form of a beverage container.

3. The method of claim 2 where the form of the boat fender is selected from the group consisting of a short neck beer bottle, long neck beer bottle soda can, a beer can, a wine bottle, a liquor bottle, and a liquor bottle.

4. The method of claim 1 where the form of the boat fender is selected from the group consisting of a package of candy, a package of cigarettes, and a container of perfume.

5. The method of claim 1 where the attachment member is a flexible elongated element having a length of from 2 to 6 feet.

6. The method of claim 1 where the attachment member is a strap member.

7. The method of claim 6 where the strap member has a connector including a hook portion and a fabric portion.

8. The method of claim 1 where the boat fender has a height of from 12 to 72 inches, a width of from 4 to 24 inches, and depth of 4 to 24 inches.

9. The method of claim 1 where the boat fender at least in part comprises a resilient material.

10. The method of claim 1 where the boat fender has a size that is from 3 to 10 times larger than said product container.

11. A method of displaying an advertisement on a boat for a product sold in a container having a distinctive feature, comprising the steps of
(a) providing a boat fender that acts as a shock absorber, is adapted to be attached to a boat, and has an external appearance like that of the container including said distinctive feature,
said boat fender being at least in part made of a resilient material and having a height of from 12 to 72 inches, a width of from 4 to 24 inches, and depth of from 4 to 24 inches, and
(b) attaching the boat fender to the boat to thereby advertise the beverage.

12. The method of 11 where the container has a predetermined size and shape and bears a distinctive label and the boat fender has a size that is substantially larger than the predetermined size of the container but has substantially the same shape and bears substantially the same label.

13. The method of claim 12 where the boat fender is in the form of a beverage container selected from the group consisting of a short neck beer bottle, long neck beer bottle soda can, a beer can, a wine bottle, a liquor bottle, and a liquor bottle.

14. The method of claim 11 where the boat fender has an attachment member extending therefrom that enables said boat fender to be attached to a boat in a manner that positions the boat fender along a side of the boat, said attachment member being a flexible elongated element having a length of from 2 to 6 feet.

15. The method of claim 14 where the form of the boat fender is selected from the group consisting of a package of candy, a package of cigarettes, and a container of perfume.

16. The method of claim 14 where the attachment member is a strap member.

17. The method of claim 16 where the strap member has a connector including a hook portion and a fabric portion.

18. The method of claim 11 where the boat fender has a size that is from 3 to 10 times larger than said container.

19. A method of advertising a brand of beverage comprising the steps of
(a) providing a boat fender configured to resemble the appearance of a container for the specific brand of beverage,
said boat fender including
a body made at least in part of a shock absorbing material,
an attachment member extending from the body that enables the boat fender to be manually attached and detach to the boat,
indicia on the exterior of the body corresponding to a trademark representing the brand of beverage, said trademark being visible when the boat fender is attached to the boat, and
(b) attaching said boat fender to a boat by said attachment member such that the boat fender is along a side of the boat.

20. The method of claim 19 where the beverage container has a predetermined size and shape and bears a distinctive label including the trademark and the boat fender has a size that is substantially larger than the predetermined size of the beverage container but has substantially the same shape and bears substantially the same label.

21. The method of claim 20 where the boat fender has a height of from 12 to 72 inches, a width of from 4 to 24 inches, and a depth of from 4 to 24 inches, and the attachment member is a flexible elongated element having a length of from 2 to 6 feet.

22. The method of claim 19 where the shock absorbing material is a resilient material.

23. The method of claim 19 where the boat fender has a size that is from 3 to 10 times larger than said container.

24. The method of claim 19 where the boat fender is in the form of a beverage container selected from the group consisting of a short neck beer bottle, long neck beer bottle soda can, a beer can, a wine bottle, a liquor bottle, and a liquor bottle.

25. The method of claim 19 where the form of the boat fender is selected from the group consisting of a package of candy, a package of cigarettes, and a container of perfume.

26. A method of displaying an advertisement on a boat for a branded product sold in a container under a trademark, comprising the steps of
(a) obtaining from the owner of the trademark the right to make and sell a boat fender simulating the container and using the trademark in connection with the boat fender,
(b) selling to boaters under such license the boat fender simulating the container and employing the trademark, and
(c) said boaters attaching the boat fender to a boat to thereby advertise the product.

27. A device for advertising a brand of beverage including
a boat fender with a shock absorbing body
an attachment member extending from the body that enables the boat fender to be manually attached and detach to a boat,
said body simulating the appearance of a container for the beverage and including a distinctive feature serving as a trademark for the beverage,
said boat fender having a size that is substantially larger than the beverage container for the beverage but has substantially the same shape and appearance.

28. The device of claim 27 where the body has indicia on the exterior of the body corresponding to a trademark representing the brand of beverage, said trademark being visible when the boat fender is attached to the boat.

29. The device of claim 27 where the boat fender is in the form of a long neck beer bottle.

30. The device of claim 27 where the boat fender is in the form of a short neck beer bottle.

31. The device of claim 27 where the boat fender is in the form of a soda can.

32. The device of claim 27 where the boat fender is in the form of a beer can.

33. The device of claim 27 where the boat fender is in the form of a wine bottle.

34. The device of claim 27 where the boat fender is in the form of a liquor bottle.

35. The device of claim 27 where the attachment member is a rope member.

36. The device of claim 27 where the attachment member is a strap member.

37. The device of claim 36 where the strap member has a connector including a hook portion and a fabric portion.

38. The device of claim 27 where the attachment member is a flexible elongated element having a length of from 2 to 6 feet.

39. The device of claim 27 where the boat fender has a height of from 12 to 72 inches, a width of from 4 to 24 inches, and a depth of from 4 to 24 inches.

40. The device of claim 27 where the boat fender at least in part comprises a resilient material.

41. The device of claim 27 where the boat fender has a size that is from 3 to 10 times larger than said container.

42. The device of claim 27 where the attachment member is connected to a top of the boat fender.
